(19) United States
(12) Patent Application Publication
(10) Pub. No.: US 2011/0195594 A1
(43) Pub. Date: Aug. 11, 2011

(54) RJ-45 CONNECTOR AND ELECTRONIC DEVICE HAVING THE SAME

(75) Inventors: MING-CHIH HSIEH, Tu-Cheng (TW); TSUNG-HSI LI, Tu-Cheng (TW)

(73) Assignee: HON HAI PRECISION INDUSTRY CO., LTD., Tu-Cheng (TW)

(21) Appl. No.: 12/755,433

(22) Filed: Apr. 7, 2010

(30) Foreign Application Priority Data
Feb. 8, 2010 (TW) 99103738

(51) Int. Cl. H01R 13/627; H01R 24/00

(52) U.S. Cl. 439/353; 439/660

(57) ABSTRACT

A Registered Jack-45 (RJ-45) connector includes a main body, and a cable electrically connected to a rear end of the main body. The main body includes a resilient latching piece formed on a top of the main body. Two opposite sides of the main body each define a slot adjacent to the rear end of the main body, with opposite ends of the slot extending through the top and a bottom of the main body, respectively.

### BACKGROUND

1. Technical Field

The present disclosure relates generally to a Registered Jack-45 (RJ-45) connector, and an electronic device having the RJ-45 connector.

2. Description of Related Art RJ-45 connectors are widely used for data communication purposes. Sometimes, an electronic device needs an RJ-45 connector, to connect to an inserting interface of another electronic device. However, it is often difficult to firmly fix a common RJ-45 connector to an electronic device.

### BRIEF DESCRIPTION OF THE DRAWINGS

FIG. 1 is an exploded, isometric view of an embodiment of an electronic device with a Registered Jack-45 (RJ-45) connector.

FIG. 2 is an assembled, isometric view of the electronic device of FIG. 1.

### DETAILED DESCRIPTION

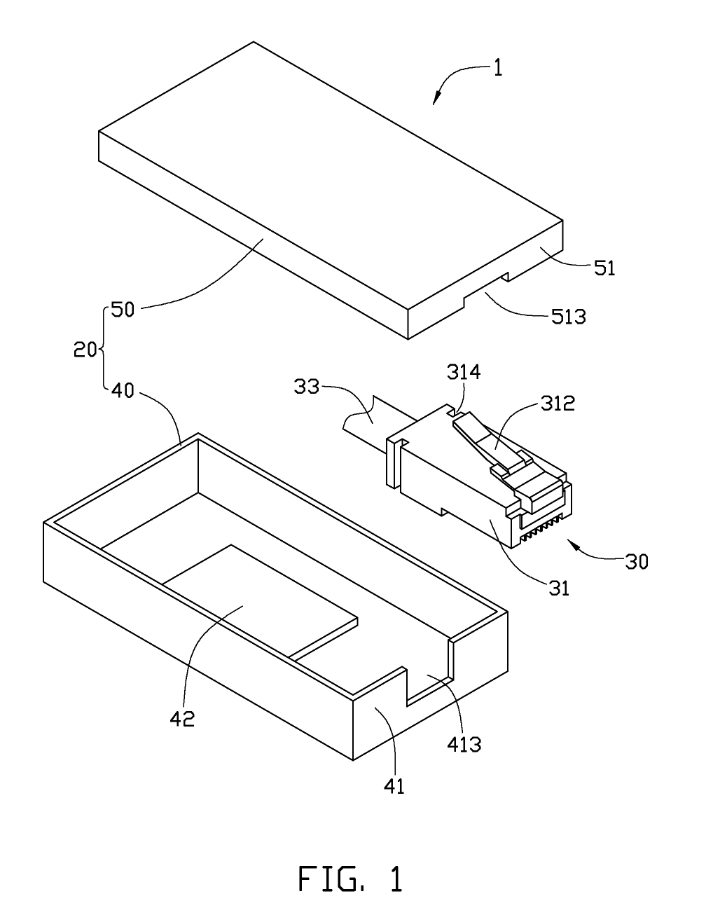

Referring to FIG. 1, an embodiment of an electronic device 1 includes a chassis 20, and a Registered Jack-45 (RJ-45) connector 30.

The chassis 20 includes a base 40 and cover 50. A circuit board 42 is installed in the base 40. The base 40 includes a first sidewall 41. A first opening 413 is defined in the first sidewall 41, with an end of the first opening 413 extending through a top of the first sidewall 41. The cover 50 includes a second sidewall 51. A second opening 513 is defined in the second sidewall 51, with an end of the second opening 513 extending through a bottom of the second sidewall 51 and aligning with the first opening 413 of the first sidewall 41.

The RJ-45 connector 30 includes a main body 31, and a cable 33 electrically connected to a rear end of the main body 31. A resilient latching piece 312 is formed on a front end of a top of the main body 31. Each of two opposite sides of the main body 31 defines a slot 314 adjacent to the rear end of the main body 31, with opposite ends of the slot 314 extending through the top and a bottom of the main body 31 respectively.

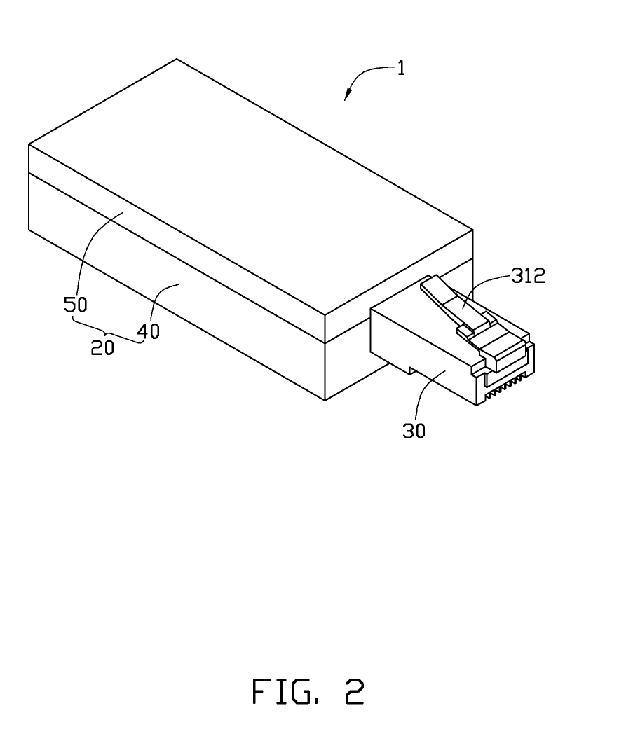

Referring to FIG. 2, in assembly, the RJ-45 connector 30 is placed over the first opening 413 of the base 40 of the chassis 20, with a front end of the RJ-45 connector 30 exposed outside of the base 40, and the slots 314 of the RJ-45 connector 30 correspondingly aligning with portions of the first sidewall 41 bounding opposite sides of the first opening 413. The RJ-45 connector 30 is pressed down, to allow the slots 314 of the RJ-45 connector 30 to correspondingly engage with the portions of the first sidewall 41 bounding the opposite sides of the first opening 413, and allow the bottom of the main body 31 of the RJ-45 connector 30 to abut against a section of the first sidewall 41 bounding a bottom of the first opening 413. The cable 33 is received in the base 40 and electrically connected to the circuit board 42. The cover 50 is fixed in place over the base 40 with screws or latches (not shown), with portions of the second sidewall 51 bounding opposite sides of the second opening 513 engaging with upper sections of the slots 314 of the RJ-45 connector 30, and the top of the main body 31 of the RJ-45 connector 30 abutting against a section of the second sidewall 51 bounding a top of the second opening 513. Thereby, the electronic device 1 is assembled, with the RJ-45 connector 30 firmly fixed to the chassis 20.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A Registered Jack-45 (RJ-45) connector, comprising:
a main body comprising a resilient latching piece formed on a top of the main body, two opposite sides of the main body each defining a slot adjacent to a rear end of the main body, with opposite ends of the slot extending through the top and a bottom of the main body, respectively; and
a cable electrically connected to the rear end of the main body.

2. An electronic device, comprising:
a base comprising a first sidewall defining a first opening, with an end of the first opening extending through a top of the first sidewall;
a circuit board installed in the base;
a cover covered to the base, the cover comprising a second sidewall, a second opening defined in the second sidewall, with an end of the second opening extending through a bottom of the second sidewall and aligning with the first opening of the first sidewall; and
a Registered Jack-45 (RJ-45) connector comprising a main body, and a cable received in the base and electrically connected to the main body and the circuit board, two opposite sides of the main body each defining a slot through a top and a bottom of the main body, the slots correspondingly engaging with portions of the first sidewall bounding opposite sides of the first opening and portions of the second sidewall bounding opposite sides of the second opening.

3. An electronic device, comprising:
a chassis comprising a sidewall, the sidewall defining an opening therein;
a circuit board installed in the chassis; and
a Registered Jack-45 (RJ-45) connector comprising a main body, and a cable received in the chassis and electrically connected to the main body and the circuit board, two opposite sides of the main body each defining a slot through a top and a bottom of the main body, the slots correspondingly engaging with portions of the sidewall bounding opposite sides of the opening of the chassis, the top and the bottom of the main body resisting against portions of the sidewall bounding a top and a bottom sides of the opening of the chassis, respectively.
